(19) United States
(12) Patent Application Publication
(10) Pub. No.: US 2026/0169172 A1
(43) Pub. Date: Jun. 18, 2026

(54) SYSTEM AND METHOD FOR DYNAMIC VEHICLE SENSOR CALIBRATION

(71) Applicant: Torc Robotics, Inc., Blacksburg, VA (US)

(72) Inventors: Andre Scholich, Leipzig (DE); Chandramouli Gnanasambandham, Stuttgart (DE); Jonas Torzewski, Stuttgart (DE); Biswanath Behera, Stuttgart (DE)

(21) Appl. No.: 18/979,766

(22) Filed: Dec. 13, 2024

(51) Int. Cl. G01S 19/23; G01D 18/00

(52) U.S. Cl. CPC G01S 19/235; G01D 18/00

(57) ABSTRACT

A system for dynamic vehicle calibration sensor is provided. The system includes a first sensor and a second sensor located on first and second moving objects. The first sensor and the second sensor generate respective first and second signals relating to (i) the first moving object, a second moving object in a vicinity of the first moving object, and/or an object in the vicinity of the first moving object, and (ii) the first moving object in the vicinity of the second moving object, the second moving object, and/or the object in the vicinity of the second moving object, while the first and second moving objects are moving along a pathway. The system includes a processing device that compares the first signal from the first sensor and the second signal from the second sensor to determine whether a discrepancy beyond a predetermined threshold exists between the first and second signals.

### TECHNICAL FIELD

The field of the disclosure relates to vehicle sensor calibration and, in particular, to a system for calibrating vehicle sensors in a dynamic state where the vehicles are in motion relative to each other.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

The vehicle therefore includes a variety of sensors that gather data which permits the vehicle to safely travel along a route. To ensure continued safe travel of the vehicle, calibration of the sensors is performed periodically. Such sensor calibration is typically performed statically on a dedicated test field, which necessitates that the vehicle is not available for use along routes until the calibration process is complete. Static sensor calibration can involve the passage of the vehicle along a test field which can only be occupied by one vehicle at a time. Additional inspections of the vehicle, such as tire misalignment, damaged/vandalized chassis elements, dirty sensors, or the like, are typically performed manually and involve a time-consuming process. Thus, the conventional sensor calibration process can lead to extended downtime of the vehicle, resulting in potential delivery and/or transport delays.

Accordingly, there exists a need for a system and a method of dynamic vehicle sensor calibration which allows for calibration during normal operation of the vehicle along planned routes. These and other needs are met by the exemplary system for dynamic vehicle sensor calibration discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for dynamic vehicle sensor calibration is provided. The system includes a first vehicle including at least one first sensor. The at least one first sensor is configured to generate a first signal relating to at least one of the first vehicle, a second vehicle in a vicinity of the first vehicle, or an object in the vicinity of the first vehicle, while the first vehicle is moving along a pathway. The system includes the second vehicle including at least one second sensor. The at least one second sensor is configured to generate a second signal relating to at least one of the first vehicle in the vicinity of the second vehicle, the second vehicle, or the object in the vicinity of the second vehicle, while the second vehicle is moving along the pathway. The system includes a processing device in communication with the first vehicle and the second vehicle. The processing device is configured to execute instructions stored in a memory to perform operations that include comparing the first signal from the at least one first sensor and the second signal from the at least one second sensor to determine whether a discrepancy beyond a predetermined threshold exists between the first signal and the second signal. In some embodiments, more than two vehicles can be used for performing the dynamic calibration. In such embodiments, the processing device can compare the first signal from the first vehicle with signals from sensors of the other vehicles to determine if a discrepancy beyond the predetermined threshold exists. In such embodiments, the system can also rely on the majority similar signals compared to the minority dissimilar signal, e.g., two similar signals indicate the correct measurement vs. a single different signal).

In some embodiments, the at least one of the first vehicle or the second vehicle can be an autonomous or a semi-autonomous vehicle. In some embodiments, the vehicle can be a non-autonomous vehicle. In some embodiments, the at least one first sensor or the at least one second sensor can be a camera, LIDAR, radar, or the like. In some embodiments, the at least one first sensor or the at least one second sensor can be an accelerometer, a gyroscope, a global positioning system sensor, or the like. In some embodiments, the at least one second sensor can be of a same type as the at least one first sensor. In some embodiments, the at least one second sensor can be of a different type as the at least one first sensor.

In some embodiments, the predetermined threshold for the discrepancy can be about 10% or greater. In some embodiments, the predetermined threshold for the discrepancy can be about 15% or greater. If the discrepancy is beyond or above the predetermined threshold, the operations can include transmitting an alert to a mission control (and/or the vehicles) regarding a manual calibration request. If the discrepancy is below the predetermined threshold, the operations can include generating a confirmation of sensor calibration.

In some embodiments, the operations can include positioning the first vehicle and the second vehicle adjacent to each other before sensor calibration is performed. In some embodiments, the operations can include positioning the first vehicle as a leading vehicle on the pathway relative to the second vehicle such that the vehicle is a trailing vehicle on the pathway. The first signal generated by the at least one first sensor of the first vehicle can be a current location determined by a global positioning system (GPS). In some embodiments, the current location value determined by the global positioning system can be a localization step performed by the first vehicle. In some embodiments, the second signal generated by the at least one second sensor of the second vehicle can be an estimated current location of the first vehicle.

In some embodiments, the operations can include determining whether the discrepancy beyond the predetermined threshold exists between the current location from the at least one first sensor and the estimated current location from the at least one second sensor. In some embodiments, the operations can include switching positions between the first and second vehicles to repeat a calibration process.

In some embodiments, the first signal generated by the at least one first sensor of the first vehicle is indicative of detection of the object in the vicinity of the first and second vehicles. The second signal generated by the at least one second sensor of the second vehicle can be indicative of detection of the object in the vicinity of the first and second vehicles. The operations can include determining whether the discrepancy beyond the predetermined threshold exists between the first and second signals representative of the detected object. In some embodiments, the operations include inspecting an outside of the second vehicle with the at least one second sensor and inspecting an outside of the first vehicle with the at least one first sensor while the first and second vehicles are adjacent to each other to determine at least one of tire misalignment, chassis damage, or occluded sensors.

In another aspect, an exemplary computer-implemented method for dynamic vehicle sensor calibration is provided. The method includes generating a first signal with at least one first sensor of a first vehicle while the first vehicle is moving along a pathway. The first signal relates to at least one of the first vehicle, a second vehicle in a vicinity of the first vehicle, or an object in the vicinity of the first vehicle. The method includes generating a second signal with at least one second sensor of the second vehicle while the second vehicle is moving along the pathway. The second signal relates to at least one of the second vehicle, the first vehicle in the vicinity of the second vehicle, or the object in the vicinity of the second vehicle. The method includes executing instructions stored in a memory with a processing device in communication with the first vehicle and the second vehicle to perform operations that include comparing the first signal from the at least one first sensor and the second signal from the at least one second sensor to determine whether a discrepancy beyond a predetermined threshold exists between the first signal and the second signal.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for dynamic vehicle sensor calibration.

FIG. 7 is a flowchart of a method for dynamic vehicle sensor calibration.

FIG. 8 is a diagrammatic view of a first position for leading and trailing vehicles of an exemplary system for dynamic vehicle sensor calibration.

FIG. 9 is a diagrammatic view of a second position for leading and trailing vehicles of an exemplary system for dynamic vehicle sensor calibration in which first and second vehicles switch positions relative to each other.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for dynamic vehicle sensor calibration allows for calibration for sensors on one or both vehicles during travel of the vehicles along their route, thereby avoiding static calibration on a dedicated test field which typically creates significant downtime for the vehicle. Sensor calibration can thereby be performed regularly without affecting operation of the vehicles. Such regular calibration can assist with detection of errors that could lead to the vehicle not being able to complete its mission, and resolves these errors by calibrating the sensors appropriately during operation of the vehicle. The vehicle can therefore drive and operate as much as possible to offer cost-effective service to the fleet and avoids unnecessary stops for calibration of sensors.

The exemplary system results in various advantages to operating the vehicles. Non-limiting examples of such advantages include, e.g., ensuring that sensors are working within specified ranges, determining misalignment of a sensor that could be resolved by applying correction factors while driving, determining misalignment of a sensor that cannot be resolved while driving and initiating a route re-planning to the next available calibration hub, determining a sever misalignment that cannot be resolved while driving and initiating a minimal risk maneuver (MRM) to bring the affected vehicle to a safe stop and request recovery of the vehicle, or the like. Thus, the system can assist with reducing the need for regular maintenance stops at calibration hubs (which results in downtime and costs for vehicle operation), but also can be used to route the vehicle to a calibration hub or to a safe stop if dynamic correction of the sensor misalignment is not feasible.

The system can perform the calibration in the following non-limiting manner. For example, two or more vehicles can operate in tandem for calibration while driving along the same route (e.g., as coordinated by mission control). In some embodiments, two vehicles can perform the calibration process and, when one of the vehicles is diverted onto a different route, the remaining vehicle can complete the calibration process with another vehicle associated with the fleet. The vehicles can drive such that one vehicle is in front of the other vehicle (e.g., leading and trailing vehicles). In some embodiments, calibration can be performed while the vehicles are driving side-by-side relative to each other. The leading vehicle can localize itself using, e.g., a global positioning system (GPS), or the like, and the training vehicle can localize the leading vehicle using one or more individual sensors (e.g., cameras, LiDAR, radar, combinations thereof, or the like) and/or sensor fusion (e.g., camera, LiDAR, and/or radar combined) of the trailing vehicle.

After the trailing vehicle has localized the leading vehicle with its own sensors, the vehicles can switch positions such that the previously leading vehicle is now the trailing vehicle and the previously trailing vehicle is now the leading vehicle. The calibration is repeated, now with the newly leading vehicle localizing itself using, e.g., GPS, or the like, and the newly trailing vehicle localizing the leading vehicle using one or more individual sensors and/or sensor fusion of the trailing vehicle. The localization sensor data captured in both calibration steps is compared by the system to determine if the measured or detected locations/localized data overlap with a satisfactory error margin (e.g., below a predetermined threshold).

In some embodiments, the threshold can be, e.g., below 15%, below 10%, below 5%, or the like, in discrepancy between the captured data at each stage of calibration. If the error margin has been met, the dynamic calibration is passed and approved, and the vehicles can continue to operate. If the calibration does not pass due to an elevated error margin and the sensor operation/calibration cannot be corrected, the system can generate an alert (e.g., to mission control) requesting static recalibration. It should be understood that at each stage of the calibration process, data can be acquired for only one of the vehicles or both vehicles to assist with calibration of sensors for both vehicles.

The sensor signals can be transmitted for comparison in a variety of ways. For example, either vehicle can transmit the sensor data to the other vehicle for processing of the data and comparison. In some embodiments, both vehicles can receive the sensor data from each respective vehicle participating in the cross-calibration. The sensor data (and/or comparison results) can be transmitted from one vehicle to the other with direct communication, or both vehicles can transmit the sensor data (and/or comparison results) to mission control. Mission control can perform the comparison/analysis of the sensor data and relay signals to the vehicles in addition to the resulting comparison results. Thus, mission control can be used to directly compare the sensor data from both vehicles and evaluate the impact for purposes of calibration, i.e., whether the sensor data is within a predetermined threshold and therefore indicates successfully calibrated sensors.

In some embodiments, calibration can be performed by each vehicle detecting an external object, e.g., another vehicle, a bicyclist, a pedestrian, an animal, a non-living object, or the like, in the environment around the vehicles, and using the detected object data as a comparison for calibrating the sensors. Similar to the localization data, if the detected object data is within an acceptable error margin, the calibration is successful and no further static calibration is needed. Although discussed herein as being performed with vehicles traveling in front and behind each other during calibration, it should be understood that the calibration process can be similarly performed with vehicles traveling adjacent to each other (e.g., side-by-side, or the like).

When the need for calibration is determined, mission control and/or the vehicles can communicate with each other to orchestrate routes such that two vehicles meet on a shared route to perform the on-road cross-calibration. In some embodiments, calibration can be performed after the vehicle has driven a certain number of miles and/or hours, or if routes are already close to each other because of other factors, such as initial route planning by mission control that optimized delivery on the delivery network of vehicles. For example, if a large fleet of vehicles is transporting goods on a fixed route network, the probability of vehicle sharing parts of the route during “normal” delivery or travel time is high and would allow for the dynamic calibration process to be performed. Cross-calibration is performed on the road between two or more vehicles as the vehicles travel on the road. It should be understood that as discussed herein, vehicles traveling on the road include both direct travel along the road, as well as temporary stops at stop signs or traffic signals. If the dynamic cross-calibration is successful, no additional action is taken. If measurements from cross-calibration indicate that recalibration is needed, a request can be transmitted to mission control. Mission control subsequently adapts the route of one or more of the vehicles to allow for the static recalibration to occur. In some embodiments, one or more of the sensors can be used to detect external damage to the vehicles, e.g., video feed for tire misalignment, damaged/vandalized chassis elements, dirty sensors, or the like.

In some embodiments, mission control can determine which two vehicles can undergo the dynamic calibration. This can be based on the number of common miles driven on the same route, or if the two vehicles are driving on the routes which are close to each other. Mission control can re-plan missions for the vehicles with a detour to accommodate a possible dynamic calibration. Mission control can re-plan routes based on several factors in the case of a static calibration necessity after cross-calibration is attempted. For example, mission control can determine how re-planning could be performed with the shortest downtime and a static calibration stop.

In some embodiments, mission control can rank the need for calibration of the two vehicles, taking into account, e.g. miles driven since the last calibration, environmental factors known to affect calibration (such as rain or wind), combinations thereof, or the like. The system can use the ranking and knowledge of previous calibration runs as to how many miles or time is required to perform each individual calibration task to request the calibrations in order from the most needed to less needed. In some embodiments, the system can take into account upcoming dynamic calibration options of the fleet network of vehicles to determine, if performing only a subset of the needed calibrations is sufficient as other options are within predefined safety ranges (e.g., have at least one location calibration every 1,000 miles, and vehicle A is at 500 miles and there is a potential other vehicle B on the route to do the calibration within 200 miles; therefore, it is permitted to skip the calibration with the current position). If no other options for calibration are within the mileage range, mission control can either request a detour of the calibration partner to enable the dynamic calibration on the road (if the detour is small), or can request the affected vehicle to travel to a calibration hub to perform a static calibration instead (if the detour for the other vehicle would be too costly or time consuming).

The exemplary system therefore allows for dynamic sensor calibration of vehicles during their mission route without necessitating that the vehicle be taken offline for the calibration process. Using this type of sensor calibration can reduce the number of static calibrations needed at a hub, resulting in reduced costs of vehicle maintenance and less downtime of the vehicles themselves. Safety of operation of the vehicles on the road is also increased using the exemplary calibration system. External inspection of the vehicles for damage and diagnostics with the assistance of a video or image feed from sensors of the respective calibration vehicles can be transmitted to mission control to increase the efficiency of maintaining the vehicles in the optimal operating conditions.

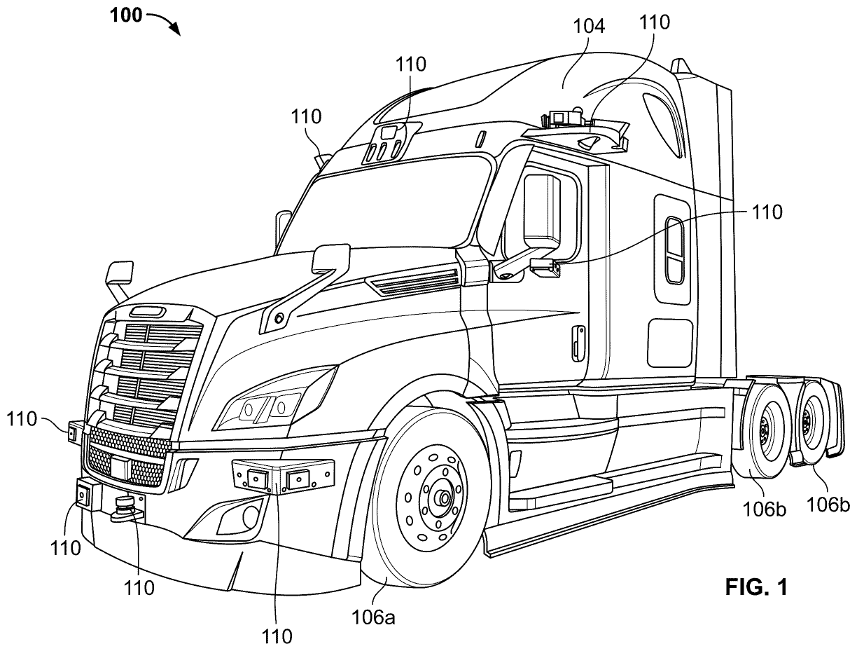

Various embodiments in the present disclosure are described with reference to FIGS. 1-9 below.

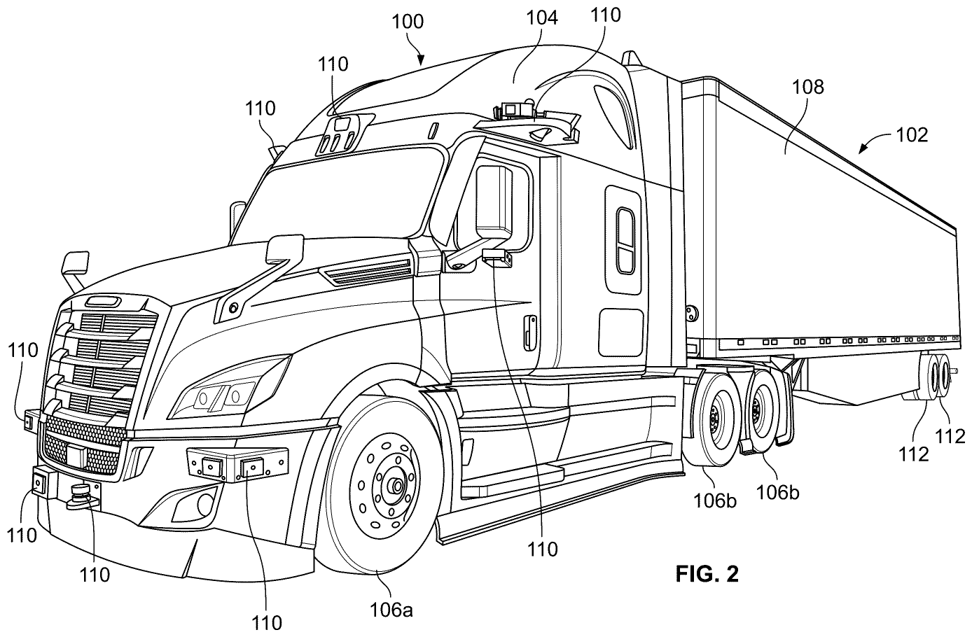

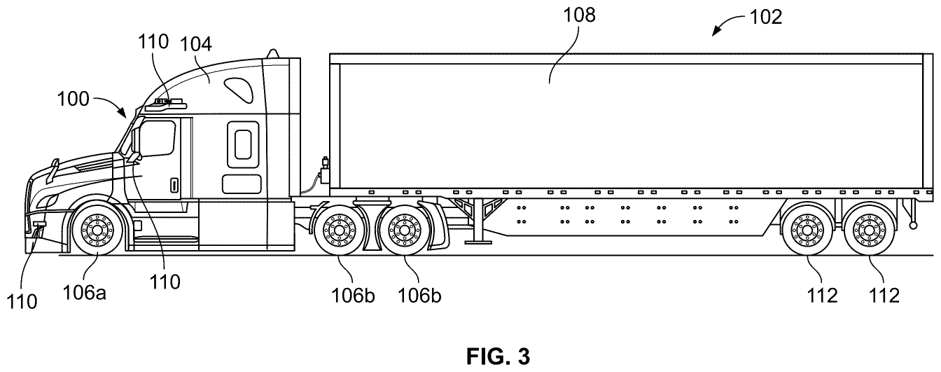

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

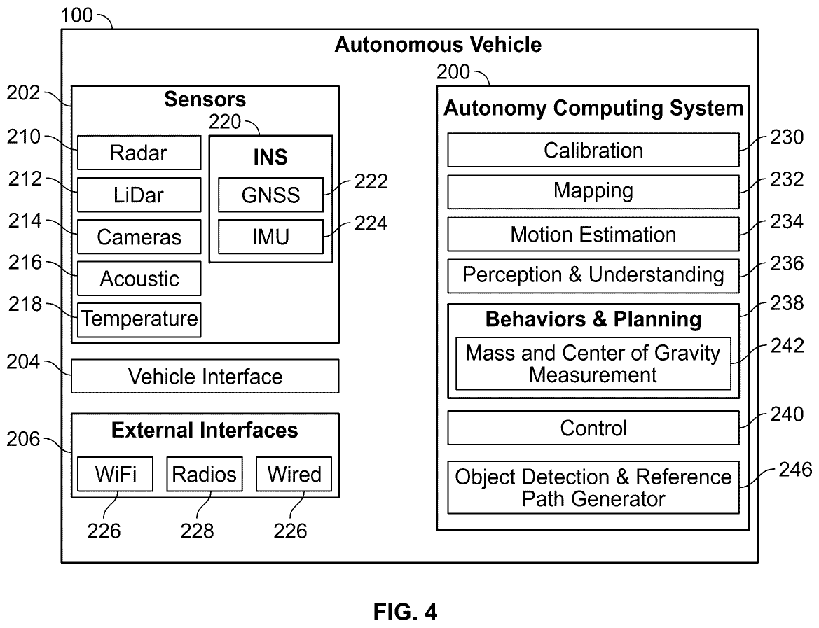

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5 g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

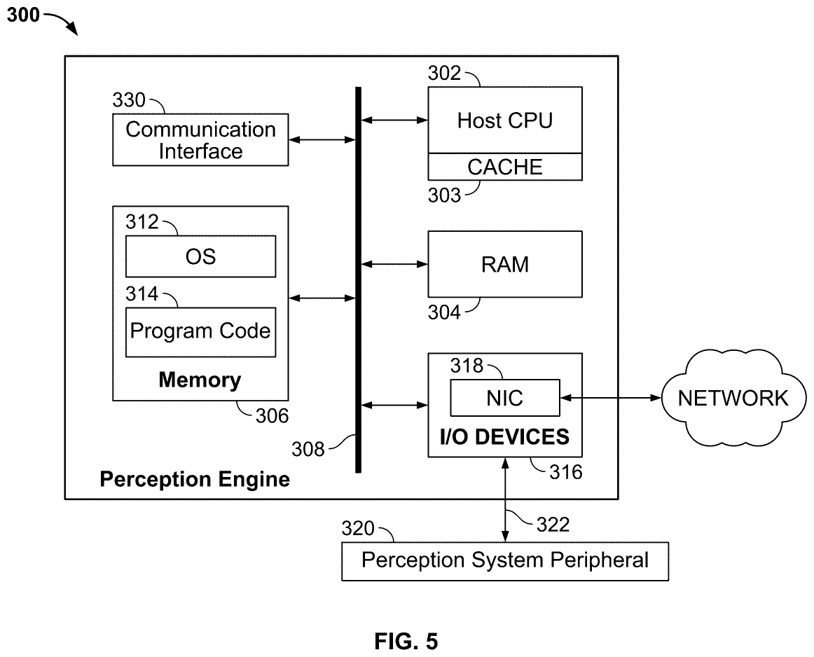

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

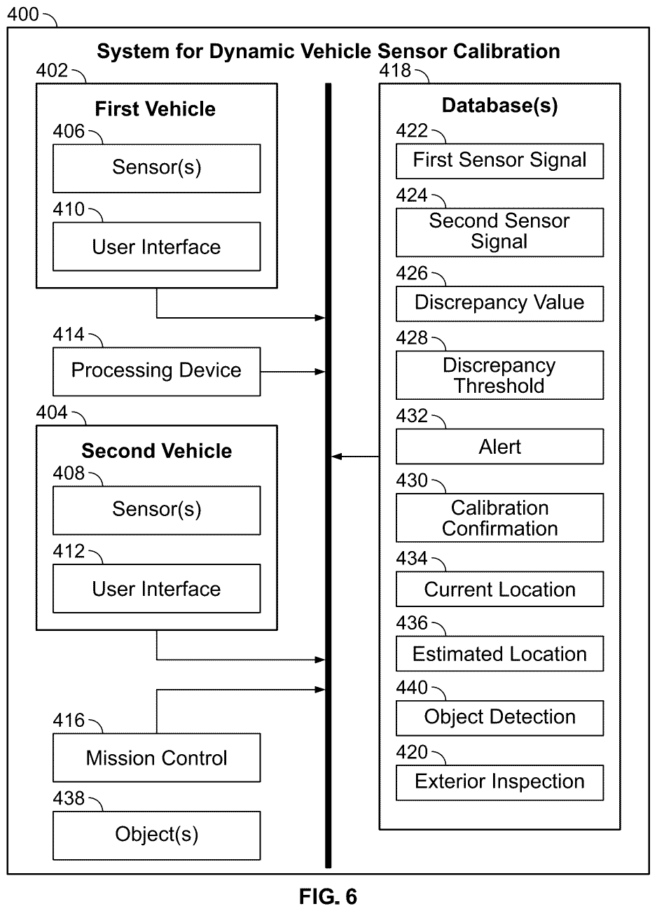

FIG. 6 is a block diagram of an exemplary system 400 for dynamic vehicle sensor calibration. The system 400 generally includes two or more vehicles (e.g., autonomous vehicle 100). The vehicles (e.g., first and second moving objects) can include at least a first vehicle 402 and a second vehicle 404. The vehicles 402, 404 can be the same or different type/model. As non-limiting examples, the vehicles 402, 404 can both be semi-trucks or passenger vehicles; or one vehicle 402 can be a semi-truck and the other vehicle 402 can be a passenger vehicle. Each vehicle 402, 404 includes one or more sensors 406, 408 (e.g., sensors 202) and, optionally, can include a user interface 410, 412 (e.g., a graphical user interface). The system 400 includes at least one processing device 414 (e.g., computing system 200, computing system 300, or the like) configured to receive and process data for performing the sensor calibration process. In some embodiments, the processing device 414 can be remote from the vehicles 402, 404 and can receive data from the vehicles 402, 404 (e.g., sensor data) for performing the calibration process. In some embodiments, the processing device 414 can be on one or both of the vehicles 402, 404. In some embodiments, the processing device 414 can be at a mission control 416 in communication with the vehicles 402, 404. In some embodiments, each of the vehicles 402, 404 and mission control 416 can include a processing device 414.

The vehicle 402, 404 (and/or mission control 416) can include one or more databases 418 (e.g., memory 306) configured to receive and electronically store data. In some embodiments, the database 416 can be stored externally from the vehicle 402, 404 and the vehicle 402, 404 can be in communication with the external database 418 for receiving and/or transmitting data associated with the system 400. For example, the database 418 can be stored at mission control 416 and sensor data can be transmitted to/from the vehicles 402, 404 for operation of the system 400. In some embodiments, the database 418 can be external to both the vehicles 402, 404 and mission control 416, and data can be transmitted to/from the respective components of the system 400.

As the vehicles 402, 404 travel along a path (e.g., during mission route), the system 400 calibrates sensors 406, 408 of one or both of the vehicles 402, 404. The calibration process is performed during normal operation of the vehicles 402, 404, including during stopping and starting at stop signs and/or traffic signals. However, because the calibration process is performed dynamically, the vehicles 402, 404 can continue on their planned route without begin taken offline for the calibration process.

As the vehicles 402, 404 travel along the path or road, the sensors 406, 408 can be used to gather data on the exterior of the respective vehicles 402, 404. In some embodiments, if the vehicles 402, 404 are hauling a trailer, the inspection by the sensors 406, 408 can include one or more portions of the trailer as well. This data can be stored as exterior inspection 420 data and can include, e.g., damage to sensors, occluded sensors, tire misalignment, deflated tires, irregular vibrations, chassis damage, damage to cargo, combinations thereof, or the like. In some embodiments, the exterior inspection 420 data can include calculations with different calibrations (e.g., positioning of the sensors) and checking where both results overlap.

For example the vehicle 402 can perform a maneuver in which it positions itself as the leading vehicle and the vehicle 404 is directly behind as the trailing vehicle. In this position, sensors 408 of the vehicle 404 can be used to analyze and perform an inspection of the rear of the vehicle 402 and/or the rear of the trailer associated with the vehicle 402. The vehicle 404 can subsequently pass on the right or left side of the vehicle 402 to continue performing an inspection of the exterior of the vehicle 402. During this repositioning of the vehicle 404 relative to the vehicle 402, the vehicle 402 can simultaneously perform an inspection of the exterior of the vehicle 404. The vehicle 404 can then position itself as the leading vehicle, allowing the vehicle 402 to perform an inspection of the rear of the vehicle 404 and/or the rear of the trailer associate with the vehicle 404. This exterior inspection 420 data can be transmitted to mission control 416 to determine if the results are satisfactory, or if additional evaluation is needed, e.g., based on detected damage.

A similar maneuver can be performed during calibration of the sensors 406, 408. In some embodiments, the leading and trailing vehicle positions can be used for the calibration process, with switching of the positions occurring during the process. In some embodiments, the vehicles 402, 404 travel in an adjacent position during the calibration process, e.g., side-by-side, or the like. In some embodiments, the calibration process can be performed as long as the vehicles are within a predetermined distance relative to each other. In some embodiments, calibration can be performed when the vehicles 402, 404 are within about, e.g., 10-80 meters inclusive, 100 meters, 150 meters, 200 meters, 250 meters, inclusive, or the like, of each other. In some embodiments, the predetermined distance between the vehicles 402, 404 can be controlled based on the respective ranges of operation of the different sensors 406, 408 being used for the calibration process, e.g., according to the sensor manufacturer specifications.

As an example, the discussion will involve the vehicle 402 positioned as the leading vehicle relative to the vehicle 404 positioned as the trailing vehicle. First, one or more of the sensors 406 of the first vehicle 402 is used to generate a first sensor signal 422. In some embodiments, the sensor signal 422 can include information relating to the first vehicle 402, such as the detected actual current location 434 of the vehicle 402 based on, e.g., a global positioning system (GPS), or the like. The one or more sensors 408 of the second vehicle 404 can be used to generate a second sensor signal 424. The sensor signal 424 can include information relating to the first vehicle 402, such as the detected location of the vehicle 402 based on, e.g., GPS, cameras, LiDAR, or the like. In particular, the sensor signal 424 can be an estimated current location 436 of the first vehicle 402 determined by the sensors 408 of the second vehicle 404. In some embodiments, the sensor signals 424 can include information from accelerometers to compare between vehicles when traveling the same route and going through a curved road. In some embodiments, the sensor signals 424 can include information relating to, e.g., assessment of obvious or external damage to the vehicle(s) which does not necessarily directly impact operation of the vehicle, but can lead to other types of damage (such as loss of cargo in case of a trailer hull damage).

In some embodiments, the estimated current location 436 can be determined using sensors 408 that are of a different type than the sensors 406 used by the first vehicle 402. In some embodiments, the same type of sensors 406, 408 can be used. The trailing position of the vehicle 404 can assist with visibility of the field-of-view of the sensors 408 for detecting the estimated location 436 of the vehicle 402. For example, the cab or front area of the vehicle 404 can include the sensors 408, with greater visibility and more accurate determination of the estimated location 436 of the vehicle 402 if the vehicle 402 is positioned directly in front of the vehicle 404.

In some embodiments, the sensor signal 422 can include information relating to the second vehicle 404, such as the estimated current location 436 of the second vehicle 404, and the sensor signal 424 can include the detected actual current location 434 of the vehicle 404 based on, e.g., GPS, or the like. The detected localization data associated with the first and second vehicles 402, 404 can thereby be obtained using sensors 406, 408 of both vehicles 402, 404. The sensor signals 422, 424 (e.g., the data associated with such signals) can be received and processed by the processing device 414 to determine the discrepancy between the signals 422, 424, which is stored as the discrepancy value 426. In particular, the processing device 414 is configured to determine the difference between the actual current location 434 and the estimated current location 436 determined from the signals 422, 424. In some embodiments, the localization information of the same object can be transformed in the same coordinate system, and further calculation of the distance either for each similar coordinate or taking a standard norm (like the square root to determine distance) can be used. The sensor 406, 408 readings are therefore used in combination to determine the location of the respective vehicles 402, 404 with the expectation that the sensor signals 422, 424 can be used to calibrate off of each other for accuracy in operation. The discrepancy between sensor signals 422, 424 provides an accurate indication of calibration needs, because having a low discrepancy when both sensors 422, 424 are not operating accurately is unlikely for a single time stamp due to the fact that the sensors 422, 424 need to introduce errors that cancel each other out. Completely different errors exist for each sensor 422, 424, because both look at the same scene from a different perspective. For multiple timestamps, it is almost impossible, because the errors of both sensors 422, 424 must continuously adapt in a way that they always cancel each other out. In some embodiments, to reduce the likelihood, the system can require different observation angles during an overtake to ensure accuracy of the discrepancy determination.

If the discrepancy value 426 is determined to be equal to or below a discrepancy threshold 428, e.g., about 5%, about 10%, about 15%, or the like, the sensors 406, 408 are considered sufficiently calibrated. In such embodiments, a calibration confirmation 430 can be transmitted to mission control 416 (and/or the vehicles 402, 404) to indicate that continued operation is permitted. If the discrepancy value 426 is determined to be above the discrepancy threshold 428, an alert 432 can be transmitted to mission control 416 (and/or the vehicles 402, 404) to indicate that further calibration will be necessary. In such cases, mission control 416 can adjust the route of the vehicle 402, 404 necessitating further sensor calibration to a maintenance hub. In severe cases where calibration is necessary for safe operation of the vehicle 402, 404, the system 400 can initiate an immediate stop of the vehicle 402, 404 (e.g., on the shoulder) and can schedule a rescue of the vehicle 402, 404.

In some embodiments, rather than or in addition to detecting characteristics associated with the vehicles 402, 404, the system 400 can rely on detection of an external object 438 by sensors 406, 408 of both vehicles 402, 404 to complete the calibration process. For example, the sensor(s) 406 of the vehicle 402 can be used to detect and characterize the external object 438 located in the vicinity or around the vehicles 402, 404 as the vehicles 402, 404 travel along the route. Simultaneously or substantially simultaneously, the sensor(s) 408 of the vehicle 404 can be used to detect the same external object 438. The data associated with this detection can be stored as object detection 440. The processing device 414 can similarly compare the object detection 440 data to determine the discrepancy between the sensor 406 readings and the sensor 408 readings.

The discrepancy can include, e.g., the type of object detected, the location of the object, the size of the object, the speed of the object, combinations thereof, or the like. In some embodiments, the system can separate the object detection in lateral and longitudinal error. If the lateral difference is above a threshold, e.g., 1 meter, or the like, the system can indicate the distance is insufficient. For example, 1 meter can be added to 2.6 meters for the vehicle width, indicating a 3.6 meter road width, which is the typical road width value. However, the analysis can be more detailed, including data on the reaction to a vehicle that is assumed to be in the wrong lane or close/far away. If the discrepancy is below the threshold 428 value, calibration confirmation 430 can be provided. If the discrepancy is above the threshold 428 value, the alert 432 can be generated. In some embodiments, the object detection can be used to supplement and confirm the calibration confirmation 430 based on the location data associated with the sensor signals 422, 424, and vice versa.

In some embodiments, the discrepancy threshold or error margin can vary depending on the type of detection being made. For example, for object detection (e.g., vehicles, objects, lanes, or the like), an error margin of about 0.5 m can be used. A longitudinal error margin can depend on the breaking distance for the vehicle 402, 404, and can be about 90% accuracy or a match. A latitudinal error margin (e.g., left, right motion) can depend on the distance of the vehicle from the detected object. In some embodiments, the discrepancy threshold can be selected based on the specification for operation of the vehicles 402, 404.

During the calibration process, if the vehicles 402, 404 become separated, mission control 416 can regulate the speed of the vehicles 402, 404 to ensure that the vehicles 402, 404 are able to position themselves in the leading/trailing vehicle orientation for completion of the calibration process. In some embodiments, another vehicle passing between the vehicles 402, 404 can create a pause or interruption in the calibration process, and continued calibration can be performed once the other vehicle moves away from the vehicles 402, 404.

In some embodiments, if the calibration process fails to be completed within a predetermine threshold period of time, e.g., about 1-2 hours, or the like, the system 400 can label the calibration unsuccessful and can either attempt calibration again after a predetermined period of time, or can transmit the alert 432 necessitating a static calibration. If the calibration process is successful, the calibrated vehicle 402, 404 can skip calibration stops along the mission route. In some embodiments, if the calibration process fails, the vehicle 402, 404 can be actuated to operate with reduced performance to ensure safer driving.

In some embodiments, the system 400 can be used for calibration of sensors 404, 406 associated with determination of the location of the vehicles 402, 404. In some embodiments, the system 400 can be used for calibration of other types of sensors 404, 406 associated with the vehicles 402, 404. For example, an accelerometer can be tested in a similar manner, with the vehicle 402 (leading) accelerating at a rate determined by the sensor 404, and the vehicle 404 (trailing) measuring the acceleration rate with its sensor 406. A comparison of these readings indicates if there is a discrepancy of the actual and detected acceleration of the vehicle 402 to determine if the sensors 404, 406 are calibrated. The vehicles 402, 404 can change positions relative to each other to similarly perform the calibration process for the vehicle 404.

In some embodiments, internal IMU sensors of one vehicle 402 can be compared to the external measurements of the other vehicle 402 for the first vehicle 402, observing at different angles and performing different driving maneuvers. As a non-limiting example, two vehicles can drive next to each other for a few seconds with a constant velocity and try to measure the distance of a far away stationary object (e.g., a traffic sign, lamp post, or the like). If there are discrepancies in the measured distances, the system 400 can determine that one sensor is wrong. This approach can be used for radar, LiDAR, or the like. As another non-limiting example, on a relatively long straight highway section, one vehicle can drive at a constant velocity and executes a sinusoidal trajectory of a given frequency and amplitude (e.g., frequency of 0.2 Hz and amplitude of 10 cm). The vehicle trailing can use its perception system (e.g., LiDAR, radar, camera, combinations thereof, or the like) to detect the frequency and amplitude and the detected values must be within a certain accuracy/threshold to indicate calibration is complete.

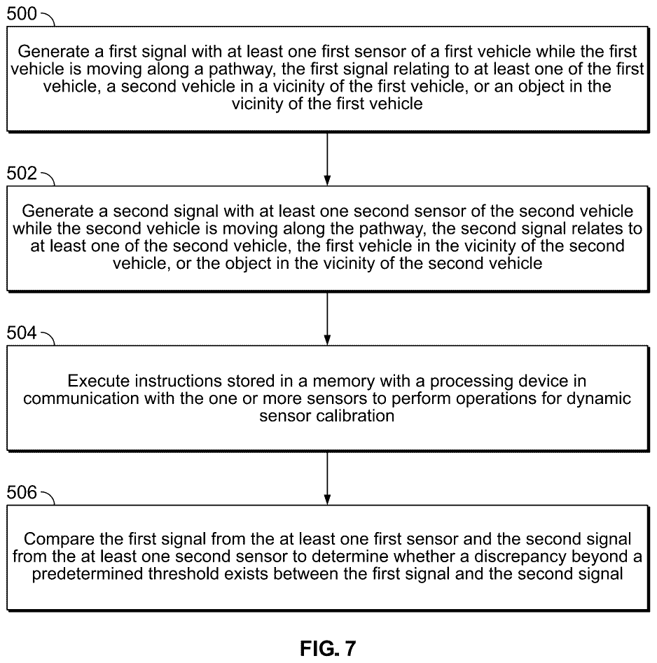

FIG. 7 is a flowchart of a method of dynamic vehicle sensor calibration by the exemplary system 400 discussed herein. At 500, a first signal is generated with at least one first sensor of a first vehicle while the first vehicle is moving along a road or pathway. The first signal relates to at least one of the first vehicle, the second vehicle in a vicinity of the first vehicle, and/or an object in the vicinity of the first vehicle. At 502, a second signal is generated with at least one second sensor of the second vehicle while the second vehicle is moving along the pathway. The second signal relates to at least one of the second vehicle, the first vehicle in the vicinity of the second vehicle, and/or the object in the vicinity of the second vehicle.

At 504, instructions stored in a memory are executed with a processing device in communication with the one or more sensors to perform operations for dynamic sensor calibration. At 506, the first signal from the at least one first sensor is compared to the second signal from the at least one second sensor to determine whether a discrepancy beyond a predetermined threshold exists between the first and second signals. If a discrepancy exists beyond the threshold, additional calibration of the sensors is needed. If a discrepancy does not exist beyond the threshold, calibration can be completed and confirmation of calibration can be transmitted to mission control.

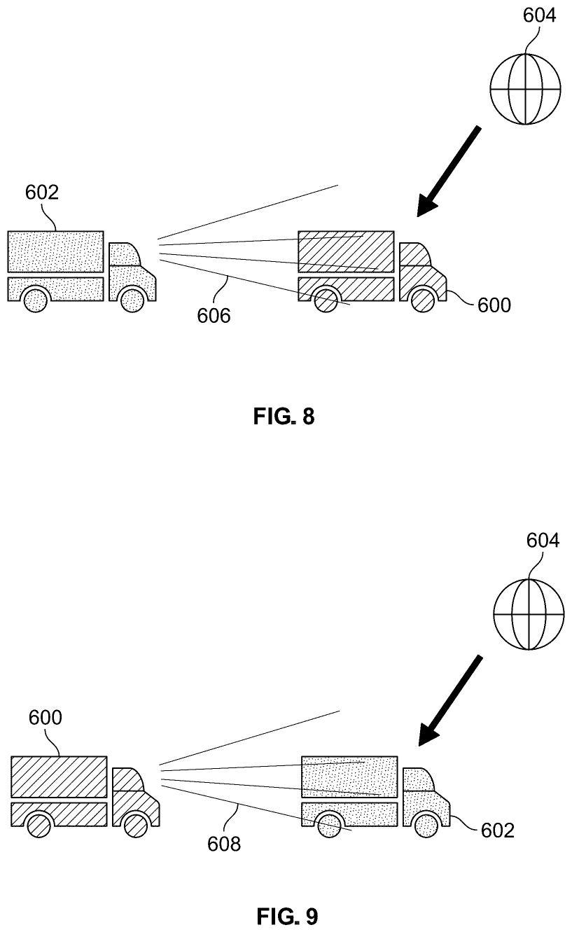

FIGS. 8 and 9 diagrammatically illustrate the leading and trailing positions of vehicles 600, 602 (e.g., vehicles 402, 404) during the dynamic calibration process. The example illustrated in FIGS. 8 and 9 involves calibration of location-based sensors for the vehicles 600, 602, although it should be understood that other sensors can be similarly calibrated. The vehicle 600 is first positioned as the leading vehicle relative to the trailing vehicle 602. The vehicle 600 can receive localization data from a source 604, e.g., GPS, or the like. This can be determined as the actual current position of the vehicle 600. Simultaneously, the vehicle 602 can rely on its sensors to obtain readings 606 detecting the estimated location of the vehicle 600. The signals from the source 604 and the estimated location readings 606 can be compared to determine if the sensors of the vehicle 602 are calibrated.

As shown in FIG. 9, the vehicles 600, 602 can change places such that the vehicle 600 is in the trailing position. At this stage, the vehicle 602 can receive localization data from the source 604, e.g., GPS, or the like, which represents the actual current position of the vehicle 602. Simultaneously, the vehicle 600 can rely on its sensors to obtain readings 608 detecting the estimated location of the vehicle 602. The signals from the source 604 and the estimated location readings 608 can be compared to determine if the sensors of the vehicle 600 are calibrated. This calibration can be performed efficiently during operation of the vehicles 600, 602, allowing both vehicles to continue operation until a lack of sensor calibration is detected. The system therefore results in reduced downtime and improved overall operation of vehicles 600, 602.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for dynamic vehicle sensor calibration, comprising:
at least one first sensor configured to be located on a first moving object, wherein the at least one first sensor is configured to generate a first signal relating to at least one of the first moving object, a second moving object in a vicinity of the first moving object, or an object in the vicinity of the first moving object, while the first moving object is moving along a pathway;
at least one second sensor configured to be located on the second moving object, wherein the at least one second sensor is configured to generate a second signal relating to at least one of the first moving object in the vicinity of the second moving object, the second moving object, or the object in the vicinity of the second moving object, while the second moving object is moving along the pathway; and
a processing device in communication with the first moving object and the second moving object, wherein the processing device is configured to execute instructions stored in a memory to perform operations comprising:
comparing the first signal from the at least one first sensor and the second signal from the at least one second sensor to determine whether a discrepancy beyond a predetermined threshold exists between the first signal and the second signal.

2. The system of claim 1, wherein at least one of the first moving object or the second moving object is an autonomous or a semi-autonomous vehicle.

3. The system of claim 1, wherein the predetermined threshold for the discrepancy is 10% or greater.

4. The system of claim 1, wherein if the first and second signals are related to the object in the vicinity of the first and second moving objects, the discrepancy includes at least one of a type of the object detected, a location of the object, a size of the object, and/or a speed of the object.

5. The system of claim 1, wherein if the discrepancy is beyond the predetermined threshold, the operations comprise transmitting an alert to a mission control regarding a manual calibration request.

6. The system of claim 1, wherein if the discrepancy is below the predetermined threshold, the operations comprise generating a confirmation of sensor calibration.

7. The system of claim 1, wherein the operations comprise positioning the first moving object and the second moving object adjacent to each other before sensor calibration is performed.

8. The system of claim 7, wherein the operations comprise positioning the first moving object as a leading vehicle on the pathway relative to the second moving object such that the second moving object is a trailing vehicle on the pathway.

9. The system of claim 7, wherein the first signal generated by the at least one first sensor of the first moving object is a current location determined by a global positioning system (GPS).

10. The system of claim 9, wherein the current location value determined by the global positioning system is a localization step performed by the first moving object.

11. The system of claim 9, wherein the second signal generated by the at least one second sensor of the second moving object is an estimated current location of the first moving object.

12. The system of claim 11, wherein the at least one second sensor is of a same type as the at least one first sensor.

13. The system of claim 11, wherein the at least one second sensor is of a different type as the at least one first sensor.

14. The system of claim 11, wherein the operations comprise determining whether the discrepancy beyond the predetermined threshold exists between the current location from the at least one first sensor and the estimated current location from the at least one second sensor.

15. The system of claim 14, wherein the operations comprise switching positions between the first and second moving objects to repeat a calibration process.

16. The system of claim 7, wherein the first signal generated by the at least one first sensor of the first moving object is indicative of detection of the object in the vicinity of the first and second moving objects, the second signal generated by the at least one second sensor of the second moving object is indicative of detection of the object in the vicinity of the first and second moving objects, and the operations comprise determining whether the discrepancy beyond the predetermined threshold exists between the first and second signals representative of the detected object.

17. The system of claim 7, wherein the operations comprise inspecting an outside of the second moving object with the at least one second sensor and inspecting an outside of the first moving object with the at least one first sensor while the first and second moving objects are adjacent to each other to determine at least one of tire misalignment, chassis damage, or occluded sensors.

18. A computer-implemented method for dynamic vehicle sensor calibration, comprising:
generating a first signal with at least one first sensor configured to be located on a first moving object while the first moving object is moving along a pathway, wherein the first signal relates to at least one of the first moving object, a second moving object in a vicinity of the first moving object, or an object in the vicinity of the first moving object;
generating a second signal with at least one second sensor configured to be located on the second moving object while the second moving object is moving along the pathway, wherein the second signal relates to at least one of the second moving object, the first moving object in the vicinity of the second moving object, or the object in the vicinity of the second moving object; and
executing instructions stored in a memory with a processing device in communication with the first moving object and the second moving object to perform operations comprising:
comparing the first signal from the at least one first sensor and the second signal from the at least one second sensor to determine whether a discrepancy beyond a predetermined threshold exists between the first signal and the second signal.

19. The method of claim 18, wherein the operations comprise positioning the first moving object as a leading vehicle on the pathway relative to the second moving object such that the second moving object is a trailing vehicle on the pathway.

20. The method of claim 18, wherein the first signal generated by the at least one first sensor of the first moving object is a current location determined by a global positioning system (GPS), and wherein the second signal generated by the at least one second sensor of the second moving object is an estimated current location of the first moving object.
